(19) United States
(12) Patent Application Publication
(10) Pub. No.: US 2006/0190893 A1
(43) Pub. Date: Aug. 24, 2006

(54) Logic cell layout architecture with shared boundary

(75) Inventor: Shannon Vance Morton, Redland (GB)

Correspondence Address: MCDERMOTT WILL & EMERY LLP, 18191 VON KARMAN AVE., SUITE 500, IRVINE, CA, 92612-7108, US

(73) Assignee: Icera Inc., Almondsbury (GB)

(21) Appl. No.: 11/066,712

(22) Filed: Feb. 24, 2005

(51) Int. Cl. G06F 17/50

(52) U.S. Cl. 716/10

(57) ABSTRACT

Logic cell layout architecture having a shared boundary between at least two cells each forming logic functions, and a method (200) for designing a logic cell library having a shared boundary between at least two cells (12,32) is disclosed for increasing packing density and limiting the occurrence of stress between active areas and shallow trench isolation (STI) regions of logic cells within a standard cell library for semiconductor integrated circuits (IC).

### FIELD OF THE INVENTION

The present invention relates generally to semiconductor integrated circuits, and more particularly to designing standard cell library architecture layout for large scale integration of semiconductor integrated circuits.

### BACKGROUND

Conventional standard cell libraries in semiconductor integrated circuits (IC) primarily contain a logic cell layout based in a metal oxide semiconductor (MOS) environment, in particular a complimentary metal oxide semiconductor (CMOS) environment. A standard cell library is a collection of standard cells. A standard cell is a pre-designed layout of transistors or non-specific collection of logic gates that are typically designed with computer assisted design (CAD) applications. The cells are usually interconnected or wired together in a particular manner with means of a placement and routing tool to perform a specific type of logical operation in an application specific IC (ASIC). A conventional ASIC layout is typically defined by an array of logic cells arranged in adjacent rows. Such a row 10 is shown in FIG. 1. The row of cells is depicted for illustrative purposes as a physical mask layout diagram representation of abutting logic cells 12,32 bound by power and ground rails 14,16. Layout diagram representation is a well known symbolic representation of the physical layout of logic cells. Each logic cell defines a specific logic circuit. The active areas or components of the logic cell include negative-channel diffusion 24, positive-channel diffusion 26, and gate 34 layers. The components of the logic cells are wired with vias 28 and metal layer 18,20,22 to form simple logic (NMOS and PMOS) gates to perform Boolean and logic functions, for example INVERTER 12, AND, OR, NAND 32, NOR 33, XOR, XNOR, ADDERS, FLIP-FLOP, and the like. In the design of the interconnection layout, integrated circuit design rules must be observed, for example, minimum width of transistor width, minimum width of metal tracks, and the like.

Recent advancements made in semiconductor technology have enabled cell library layout designers to work on the nanometer scale. Increasing packing density improves performance by virtue of the reduction in IC area, as this reduces capacitance, which is proportional to performance. However, as a result of this technology scaling, additional problems have surfaced concerning the physical properties of the components with the cell library architecture. Such a problem includes stress occurring in materials near an interface of different materials with different crystallographic structures or thermal expansion coefficients. The stress creates strain in the active and shallow trench isolation (STI) regions 36 within the cell as shown in FIG. 2. The strain related with these physical interactions substantially effects the characteristics of the component transistors in the integrated circuit. For example, in the NMOS and PMOS devices, the impact of the stress may be severe and result in 10% variation of output performance.

There is a need for a logic cell layout and method to design and configure the arrangements of logic cells in a cell library to increase packing density to improve performance, and to reduce the impact of STI stress.

### STATEMENT OF THE INVENTION

An aspect of the invention provides a method for building an integrated circuit having a shared boundary cell architecture, comprises providing a logic cell library having at least one cell, each cell having a logic function defined by the interconnection between active regions, non-active regions and power rails of each logic cell and the non-active regions defining two edges of the cell; identifying a cell having an identified connection between an active region and the same respective power rail along an edge of each cell; and placing the identified cell in the integrated circuit and arranging the cell with an edge of the identified cell straddling the identified connection to form a boundary connection to share with another cell in the integrated circuit to form the shared boundary cell architecture.

An aspect of the invention provides a method for designing a logic cell library having cells with a shared boundary cell architecture, comprises providing a first logic cell library having at least one cell, each cell having a logic function defined by the interconnection between active regions, non-active regions and power rails of each logic cell and the non-active regions defining two edges of the cell; identifying a cell having an identified connection between an active region and a power rail along an edge of each cell; and placing the identified cell in a second logic cell library and arranging the cell with an edge of the identified cell straddling the identified connection to form a boundary to share with another cell a connection from the active region to the same respective power rail, wherein the second logic cell library forms the logic cell library having cells with a shared boundary cell architecture.

In an embodiment the identified cell has a first connection between an active region and a power rail along one edge and a second connection between an active region and a power rail along another edge, and in placing the identified cell, the cell is arranged with one edge of the identified cell straddling the first connection to form a first boundary and another edge of the identified cell straddling the second connection to form a second boundary, the first boundary to share with another cell, and the second boundary to share with a different cell. Cells may be paired with a shared boundary with other cells with shared boundaries in a row of an integrated circuit. The paired cells and cells with unshared boundaries may be placed in the same row.

In an embodiment the active regions comprise a positive diffusion area and a negative diffusion area. The shared connection may be the connection from the negative diffusion to the ground rail. The shared connection may be the connection from the positive diffusion to the power rail. The cell may share a connection from the negative diffusion to the ground rail, and a connection from the positive diffusion to the power rail. The building of the ASIC may further comprise arranging the cells library using synthesis and place and route tools into rows interconnected to effect the ASIC's function.

An aspect of the invention provides a cell in an integrated circuit having a shared boundary with at least one other adjacent cell, the cell comprising a logic function defined by the interconnection between active regions, non-active regions and power rails of each logic cell; a connection between an active region and a respective power rail shared with the adjacent cell to form the shared boundary cell architecture.

An aspect of the invention provides a cell library having a shared boundary logic cell architecture, comprising a cell comprising a shared boundary capable of being shared with another adjacent cell, the cell comprising a logic function defined by the interconnection between active regions, non-active regions and power rails of each logic cell; an edge of the cell straddling a connection between an active region and a respective power rail forming a boundary connection capable of being shared with an adjacent cell in an integrated circuit to form the shared boundary cell architecture.

### BRIEF DESCRIPTION OF THE DRAWINGS

A method for incorporating the present invention will now be described, by way of example only, with reference to the accompanying drawings, in which:

FIG. 1 shows a physical layout diagram of a row of cell structures within a CMOS semiconductor environment;

FIG. 2 shows a schematic diagram of a side view of NMOS regions of two adjacent cells;

FIG. 3A-C each show a physical layout diagram of a cell of a logic gate with conventional architecture compared with an architecture incorporating an embodiment of the invention;

FIG. 4 shows a physical layout diagram of cell structures of FIG. 1 configured in accordance with an embodiment of the invention;

FIG. 5 shows an overview of cell structures in accordance with an embodiment of the invention; and

FIG. 6A & B show flow charts of methods in accordance with an embodiments of the invention.

### DETAILED DESCRIPTION

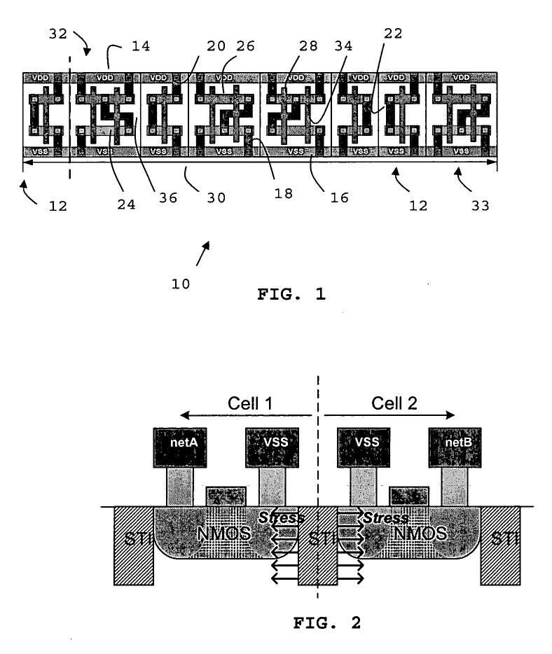

With reference to FIG. 1, a physical layout of a row of logic cells is shown arranged in a conventional manner. A conventional cell includes non-active areas 36, for example STI regions, surrounding active areas 24,26,34 within each cell. There may be STI regions within a cell, especially when the cell has more than two stages, however the STI regions 36 also act to divide and isolate active areas from one another and form cell boundaries between the cells at the block level.

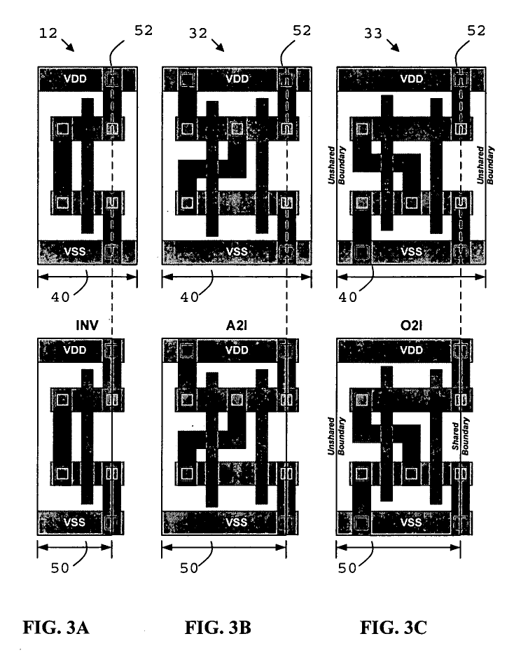

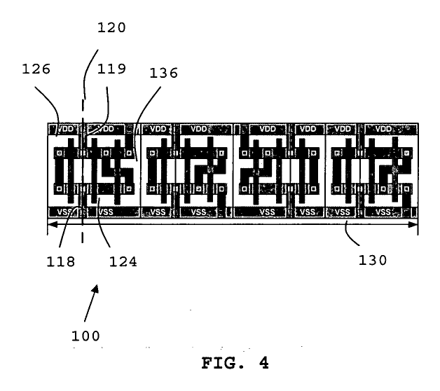

FIG. 3A-C show layout diagrams of three independent cells that form an inverter 12, NAND 32, and NOR 33, respectively. Each cell is shown with conventional architecture compared with an architecture incorporating an embodiment of the invention. The width 40 of each conventional cell includes non-active areas 36, for example STI regions, surrounding active areas 24,26,34 within each cell. The STI regions 36 act to divide and isolate active areas from one another. The active areas include the diffusion 24,26 and gate areas 34. The three cells of FIG. 3A-C are configured in the layout diagrams as having a similar characteristic of aligned nets of positive-channel 26 and negative-channel diffusion 24 along an edge of the cell as shown by dashed line 52. The term aligned refers to the connection that is made from the positive (PMOS) diffusion to the positive power rail (V_{DD}), and the connection that is made from the negative (NMOS) diffusion to the negative or ground power rail (V_{SS}). The connection is called a supply net. The supply nets do not necessarily need to be in a precise alignment with respect to each other so long as the supply nets are positioned so as not to cause a design rule violation. The supply nets should be in a position proximate an edge of the cell in order to connect the active diffusion areas with the respective power/ground rail that may be shared by the two adjacent cells and which may not alter the independent functions of each cell. An edge of the conventional cell is defined by a continuous STI region 36 between power and ground rails 14,16. The STI regions may impact performance with respect to increased IC area, and stress occurring at diffusion areas. In an embodiment, an alignment occurs when the supply net connecting the positive diffusion to power and the supply net connecting the negative diffusion to ground is along the same edge of the cell, for example along the same X-axis location, shown as dashed arrow 52. With this arrangement of positive and negative supply net. alignment, each of the cells shown have one alignment of supply nets along one edge, and lack an alignment of supply nets along the other edge. This is a typical arrangement for single stage cells, and multi-stage cells may also be arranged in this manner. This type of arrangement is referred to as “shared/unshared” (SU) arrangement. Cells that lack an alignment of supply nets along both edges have an “unshared/unshared” (UU) arrangement. In conventional cell libraries all cells are arranged in a UU cell arrangement, whereas SU cell arrangement forms the basis of an embodiment of the invention.

The width 40 of the inverter cell in a conventional UU architecture shown in FIG. 3A may be for example 0.72 μm, while the width 50 in an SU architecture may be for example 0.56 μm approximately 22% shorter. Similarly, the width 40 of the NAND and NOR gate cells in a conventional UU architecture shown in FIG. 3B-C, respectively, may each be for example 1.08 μm, while the width 50 in SU architecture may be for example 0.92 μm, approximately 15% shorter. These reductions in width are typical and result from the ability of an SU architecture to place the cell boundary across the shared supply nets 52, instead of across the more distant STI boundary.

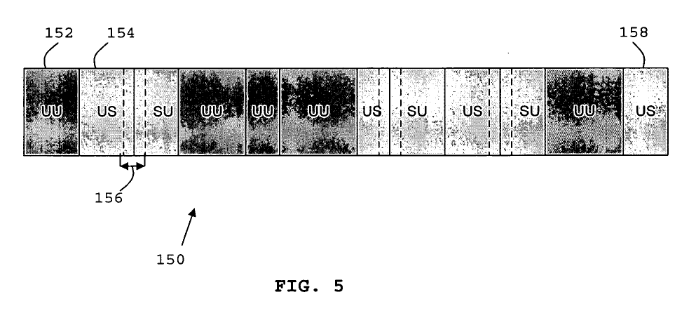

FIG. 4 shows the cell row arrangement of FIG. 1 reordered in accordance with an embodiment of the invention. A cell having shared supply nets along one edge of the cell are placed adjacent to another cell also having shared supply nets. The edges having the shared supply nets of each cell are arranged together, such that their shared borders or boundaries are adjacent and both cells share a common or overlapping or straddling shared power and ground connection as shown with shared border along dashed line 120. This reduces the row length and increases the cell packing density. Metal layer 118,119, i.e. nets, accordingly interconnect diffusions 124, with power/ground rails 126, respectively.

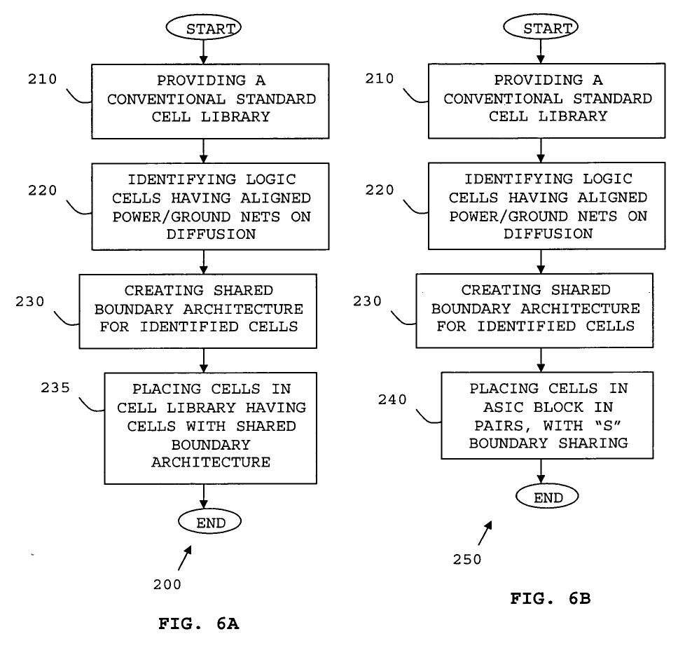

FIG. 6A & B show flow charts of methods 200, 250 in accordance with an embodiment of the invention. FIG. 6A corresponds with designing a logic cell library and FIG. 6B corresponds with building an integrated circuit. As discussed, a standard cell library is provided 210. The standard cell library has at least one cell, but typically has a collection of cells that have ground and power nets positioned proximate the same edge of the cell from which an SU cell is created. When an ASIC block is built, using automated or custom Place and Route tools SU cells are identified 220, and the cells are placed 230 such that cells identified with aligned nets on diffusions are capable of being configured 240 to share a single continuous diffusion area on an ASIC block. The edge of the identified cell is redefined to straddle the connection to form a boundary connection that may be shared with other similarly arranged or configured boundaries of other cells. Such arranged cells may be placed or stored 235 in a new or second cell library having cells with a shared boundary cell architecture. Turning to FIG. 6B, in building an integrated circuit such as an ASIC (or block thereof) cells are interconnected to effect a specific function. Those cells may be placed in an array of rows. In other words, SU cells are placed in pairs, with “S” edges sharing 240. All cells used in the block are placed in this manner where possible to maximise the number of SU pairs.

With a shared boundary configuration, the active areas, i.e. negative and positive diffusion channels 124,126 have a longer continuous length than the arrangement of FIG. 1. A longer continuous diffusion channel length reduces the number of interfaces occurring between active diffusion areas and STI regions along a row of cells. For example, for cells 12,32 in FIG. 1, the number of active diffusion area and STI region interactions is halved as shown in comparing FIG. 1 and 4. The reduction in the occurrences of stress between the STI regions and the active diffusions may correlate with an improvement in performance.

Additionally, an embodiment may comprise of a single shared supply net, along the “S” edge of two adjacent cells. For example, the two cells sharing a boundary may share the supply net from just negative diffusion to ground. With this configuration, the two adjacent cells would not share the other supply net, for example the supply net from positive diffusion to the power rail, and the respective unshared net and p-channel mask layout is sufficiently inset from the shared border so as not to violate design rules. This embodiment also reduces IC area and may optimise performance by reducing STI stress in the negative diffusion/STI regions. Of course, an embodiment may be envisaged of sharing the supply net on positive diffusion, however with current CMOS technology the advantage would not be as dramatic with respect to STI stress related issues.

After incorporating an embodiment of the invention, the packing density is increased as shown in comparing FIG. 1 and FIG. 4. The number of logic gates remain the same, however, the row length is reduced from, for example a 7.20 μm row length 30 of FIG. 1 to a 5.92 μm row length 130 FIG. 4, approximately an 18% reduction of the IC area. This resulting reduction of the IC area is typical of embodiments of the invention. Increasing packing density reduces capacitance, which is proportional to performance. Therefore, performance is improved by virtue of the reduction in IC area.

FIG. 5 shows an overview of cell structures in a row sharing aligned nets or diffusion areas as shown by 154 and arrow 156, SU represents a cell with an edge 156, i.e. “S” edge 52, that is capable of sharing a negative and/or positive supply net with another cell. The “U” edge represents an unshared boundary that is not capable of having aligned power/ground net connections along an edge that abuts an unshared edge of another cell. In the shared region 156 the negative and positive diffusion channels are continuous and extend into each SU cell, and power/ground net connections are shared. The division between unshared edges of cells is identified by continuous STI regions extending from power and ground rails between active diffusion areas. UU represents a cell having an arrangement that can not be configured to have a shared border with another cell, as shown by dashed lines 52 in FIG. 3A-C. It is important to note that it is possible to add an S edge with a power/ground connection along a boundary of UU cell, however, this is not preferred in many applications because the cell width would be extended. Most one stage cells and some two stage and multiple stage cells of CMOS gates may be represented by SU architecture. Some cells, in particular some two stage cells, are unable to be configured to have an “S” edge, and are implicitly UU architecture. Also, some cells may be configured with a shared/shared (SS) arrangement where both edges straddle boundary connectors on both sides of the cell. In the SS arrangement the SS cell may share two boundaries with two different cells that are adjacent to the SS cell. As shown in FIG. 5, an embodiment of the invention is implemented within a row of cells comprised of UU 152 and SU 154 cells. UU and SU cells may coexist in the row, however SU cells must be placed in pairs. The S edge of an SU cell 158 may also end the row as shown. Unlike the SU cells, there are no such constraints on UU cells, a UU cell 152 may be positioned in any order within the row.

An embodiment of the invention may be implemented with computer aided design (CAD) systems that are well known to a skilled person. Well known hardware description languages (HDL), such as Very High Speed Integrated Circuit Hardware Description Language (VHDL) and VERILOG, both international standard languages of Institute of Electrical and Electronic Engineers, Inc. (IEEE), may be used to implement embodiments of the invention to describe an ASIC, which is then synthesized into detailed logic functions comprising standard cells. An example of a tool to perform the synthesis is DESIGN COMPILER. (DESIGN COMPILER is a trademark in certain countries of Synopsys, Inc. of Mountain View, Calif., United States of America). The cell library may also be designed with modelling tools or logic layout programs on a CAD system to create symbolic representations such as a layout of logic functions, for example, VIRTUOSO (VIRTUOSO is a trademark in certain countries of Cadence Design Systems, Inc., of San Jose, Calif., United States of America). Of course, the ASIC may be built in rows of standard cells as mentioned above, or by other techniques known such as custom transistor level layout or the like. ASIC developers may use “place and route” (P&R) tool, or custom edits, to flip the cells as required for increasing the applicability of the technique. The placement and routing tools generate the associated mask patterns to physically wire the standard cells in the manner required to implement the ASIC function. While placement tools provide initial placement of cells in a block or IC when the routing needs are estimated, routing tools are capable of moving cells from their initial placement once the routing needs are known. Examples of “place and route” tools that may be used are PHYSICAL COMPILER and ASTRO, respectively (PHYSICAL COMPILER and ASTRO are trademarks in certain countries of Synopsys, Inc.). The hardware and software required to implement the invention, and indicated for explaining the preferred embodiment should not be limiting. Similarly, the software processes running on them may be arranged, configured or distributed in any manner suitable for performing the invention defined by the claims.

It will be understood that the shared boundary cell architecture as described above provides advantages such as increasing packing density. Another advantage of embodiments is limiting the occurrence of stress between active regions such as negative diffusion areas and STI regions of the logic cells. Additionally, embodiments may be applied to all types of ASIC's, whether the ASIC is built from a collection of logic cells of a standard cell library (as discussed above) or from other techniques such as from full custom layout and the like. It will be appreciated that specific embodiments of the invention are discussed for illustrative purposes, and various modifications may be made without departing from the scope of the invention as defined by the appended claims.

What is claimed is:

1. A method for building an integrated circuit having a shared boundary cell architecture, comprising:
providing a logic cell library having at least one cell each cell having a logic function defined by the interconnection between active regions, non-active regions and power rails of each logic cell and the non-active regions defining two edges of the cell;
identifying a cell having an identified connection between an active region and the same respective power rail along an edge of each cell; and
placing the identified cell in the integrated circuit and arranging the cell with an edge of the identified cell straddling the identified connection to form a boundary connection to share with another cell in the integrated circuit to form the shared boundary cell architecture.

2. The method of claim 1 wherein the identified cell has a first connection between an active region and a power rail along one edge and a second connection between an active region and a power rail along another edge, and in placing the identified cell, the cell is arranged with one edge of the identified cell straddling the first connection to form a first boundary and another edge of the identified cell straddling the second connection to form a second boundary, the first boundary to share with another cell, and the second boundary to share with a different cell.

3. The method of claim 1 further comprising pairing cells with a shared boundary with other cells with shared boundaries in a row of an integrated circuit.

4. The method of claim 3, further comprising placing the paired cells and cells with unshared boundaries in the same row.

5. The method of any one of claim 1 wherein the active regions comprise a positive diffusion area and a negative diffusion area.

6. The method of claim 1 wherein the shared connection is the connection from the negative diffusion to the ground rail.

7. The method of claim 1 wherein the shared connection is the connection from the positive diffusion to the power rail.

8. The method of claim 1 wherein the cell shares a connection from the negative diffusion to the ground rail, and a connection from the positive diffusion to the power rail.

9. The method of claim 1 wherein the non-active area is shallow trench isolation region.

10. The method of claim 1 wherein the active areas and non-active areas are comprised of materials having different physical properties.

11. The method of claim 1 wherein the cell height is bound by the power rails.

12. The method of claim 1 further comprising the building application specific integrated circuits (ASIC) by arranging the cells from the library using synthesis and place and route tools into rows interconnected to effect the ASIC's function.

13. The method of claim 1 wherein the cells are standard cells.

14. The method of claim 1 further comprising building application specific integrated circuits (ASIC) by arranging the cells using custom placement tools to effect the ASIC's function.

15. The method of claim 1 wherein the cells are custom transistor-level layout cells.

16. A method for designing a logic cell library having cells with a shared boundary cell architecture, comprising:
providing a first logic cell library having at least one cell, each cell having a logic function defined by the interconnection between active regions, non-active regions and power rails of each logic cell and the non-active regions defining two edges of the cell;
identifying a cell having an identified connection between an active region and a power rail along an edge of each cell; and
placing the identified cell in a second logic cell library and arranging the cell with an edge of the identified cell straddling the identified connection to form a boundary to share with another cell a connection from the active region to the same respective power rail, wherein the second logic cell library forms the logic cell library having cells with a shared boundary cell architecture.

17. The method of claim 16 wherein the identified cell has a first connection between an active region and a power rail along one edge and a second connection between an active region and a power rail along-another edge, and in placing the identified cell, the cell is arranged with one edge of the identified cell straddling the first connection to form a first boundary and another edge of the identified cell straddling the second connection to form a second boundary, the first boundary to share with another cell, and the second boundary to share with a different cell.

18. The method of claim 16 further comprising pairing cells with a shared boundary with other cells with shared boundaries in a row of an integrated circuit.

19. The method of claim 18, further comprising placing the paired cells and cells with unshared boundaries in the same row.

20. The method of claim 16 wherein the active regions comprise a positive diffusion area and a negative diffusion area.

21. The method of claim 16 wherein the shared connection is the connection from the negative diffusion to the ground rail.

22. The method of claim 16 wherein the shared connection is the connection from the positive diffusion to the power rail.

23. The method of claim 16 wherein the cell shares a connection from the negative diffusion to the ground rail, and a connection from the positive diffusion to the power rail.

24. The method of claim 16 wherein the non-active area is shallow trench isolation region.

25. The method of claim 16 wherein the active areas and non-active areas are comprised of materials having different physical properties.

26. The method of claim 16 wherein the cell height is bound by the power rails.

27. The method of claim 16 further comprising the building application specific integrated circuits (ASIC) by arranging the cells from the library using synthesis and place and route tools into rows interconnected to effect the ASIC's function.

28. The method of claim 16 wherein the cells are standard cells.

29. The method of claim 16 further comprising building application specific integrated circuits (ASIC) by arranging the cells using custom placement tools to effect the ASIC's function.

30. The method of claim 16 wherein the cells are custom transistor-level layout cells.

31. A cell in an integrated circuit having a shared boundary with at least one other adjacent cell, the cell comprising a logic function defined by the interconnection between active regions, non-active regions and power rails of each logic cell; a connection between an active region and a respective power rail shared with the adjacent cell to form the shared boundary cell architecture.

32. The cell of claim 31 further comprising a second connection between an active region and a power rail, the second connection shared with another adjacent cell.

33. The cell of claim 31 wherein the active regions comprise a positive diffusion area and a negative diffusion area.

34. The cell of claim 31 wherein the shared connection is the connection from the negative diffusion to the ground rail.

35. The cell of claim 31 wherein the shared connection is the connection from the positive diffusion to the power rail.

36. The cell of claim 31 wherein a connection from the negative diffusion to the ground rail, and a connection from the positive diffusion to the power rail are shared.

37. A cell library having a shared boundary logic cell architecture, comprising a cell comprising a shared boundary capable of being shared with another adjacent cell, the cell comprising a logic function defined by the interconnection between active regions, non-active regions and power rails of each logic cell, an edge of the cell straddling a connection between an active region and a respective power rail forming a boundary connection capable of being shared with an adjacent cell in an integrated circuit to form the shared boundary cell architecture.

38. The cell library of claim 37 further comprising a second connection between an active region and a power rail, a second edge of the cell straddling the second connection forming a second boundary connection capable of being shared with an adjacent cell in an integrated circuit.

39. The cell library of claim 37 wherein the active regions comprise a positive diffusion area and a negative diffusion area.

40. The cell library of claim 37 wherein the shared connection is the connection from the negative diffusion to the ground rail.

41. The cell library of claim 39 wherein the shared connection is the connection from the positive diffusion (126) to the power rail.

42. The cell library of claim 39 wherein a connection from the negative diffusion to the ground rail, and a connection from the positive diffusion to the power rail are shared.
